(19) United States
(12) Patent Application Publication
(10) Pub. No.: US 2012/0084006 A1
(43) Pub. Date: Apr. 5, 2012

(54) SYSTEM FOR PROVIDING WEATHER FLUCTUATION PREDICTION INFORMATION AND METHOD OF PROVIDING WEATHER FLUCTUATION PREDICTION INFORMATION

(75) Inventors: Yuichiro KAWAGUCHI, Fujisawa (JP); Teruhisa MIYAZAWA, Okaya (JP)

(73) Assignee: SEIKO EPSON CORPORATION, Tokyo (JP)

(21) Appl. No.: 13/251,635

(22) Filed: Oct. 3, 2011

(30) Foreign Application Priority Data
Oct. 4, 2010 (JP) 2010-224642

(51) Int. Cl. G06F 19/00

(52) U.S. Cl. 702/3

(57) ABSTRACT

A system for providing weather fluctuation prediction information includes at least one atmospheric pressure measurement device arranged in a specific local area, and a data processing device processing atmospheric pressure data measured by the atmospheric pressure measurement device. The atmospheric pressure measurement device includes an atmospheric pressure sensor having a pressure sensing device that changes a resonance frequency according to the atmospheric pressure and outputting the atmospheric pressure data according to an oscillation frequency of the corresponding pressure sensing device. The data processing device includes an atmospheric pressure data acquisition unit continuously acquiring the atmospheric pressure data measured by the atmospheric pressure measurement device, and a weather fluctuation prediction information generation unit generating the information to predict the weather fluctuations in a specified local area based on the atmospheric pressure data acquired by the atmospheric pressure data acquisition unit.

### BACKGROUND

1. Technical Field

The present invention relates to a system for providing weather fluctuation prediction information and a method of providing weather fluctuation prediction information, which can provide useful information to perform high-precision prediction of weather fluctuations in a limited area or a pinpointed district.

2. Related Art

AMeDAS is an abbreviation of “Automated Meteorological Data Acquisition System”, and means a “regional meteorological system”. In order to closely monitor the weather conditions, such as rain, wind, snow, and the like, temporally and regionally, the AMeDAS plays an important role in prevention and reduction of meteorological disasters by automatically performing observation of precipitation, wind direction/wind speed, atmospheric temperature, and hours of sunlight. The AMeDAS started operating as of Nov. 1, 1974, and at present, there are about 1300 observation stations that observe the amount of precipitation across the country. Among them, about 850 observation stations (at intervals of about 21 km) perform observation of wind direction/wind speed, atmospheric temperature, and hours of sunlight in addition to the observation of precipitation, and about 290 observation stations in snowy districts also perform observation of the depth of the snow.

The Meteorological Agency makes a weather forecast from extensive weather information of comprehensive nationwide weather stations or weather information of extensive areas such as cloud movement that is sent from artificial satellites. In the case of such a weather forecast of the Meteorological Agency, the observation mesh and the time mesh are large, and rainfall prediction in a wide area becomes possible from the weather forecast. However, it is very difficult to predict the rainfall in a certain limited point or area, for example, in a minimum area such as a factory having an outdoor plant. This is because if there are many non-specific factors such as topography near the factory, weather conditions that are quite different from the weather forecast, for example, a rain shower or the like, occur frequently.

Further, in accordance with the aspect of climatology such as temperature, humidity, and the amount of rainfall, the sail trend in the market and the situation of utilization in outdoor facilities are changed. Accordingly, in these businesses, it is important to acquire in real time and analyze the weather information in those areas. Further, it is important in acting comfortably at the site that a user knows what the local climate is.

However, although the weather information over a wide area can be freely acquired from the weather forecast of the Meteorological Agency, fine weather information or the result of analysis should be acquired from professional service providers, and it is also expensive.

According to the weather information collection and distribution method in the related art, content distributors obtain weather information having a relatively wide range from a weather association or the like through a weather satellite, AMeDAS, or weather radar, and transmit the obtained weather information to users. In this case, since the obtained weather information is for a relatively wide area, the weather information of the pinpointed district that the user really desires to obtain cannot be obtained, and thus, presently, the needs of users cannot be met.

Ordinary persons obtain weather information, pollen information, or the like, from “AMeDAS” or the like that is installed in the Meteorological Agency through a television or radio set. However such information is general information over a fairly wide range, and may not always be fine information in a specific area or in an area close to the specific area, which is expected by the user. In order to obtain the information, the above-described method in the related art may be used, but the introduction of new observation devices and communication equipment requires huge expenses. Further, even in the case where it is desired to transmit information that limits areas to individuals or to transmit an earthquake, volcanic prediction information, or the like, to every household, it is necessary to install a reception device in each household, and thus it forces individuals to pay expenses.

In order to solve the above-described problems, in Japanese Patent No. 3190196, JP-A-10-132956, JP-A-2000-138978, JP-A-2001-134882, JP-A-2002-044289, JP-A-2002-358321, JP-A-2002-358599, JP-A-2003-028967, and Japanese Patent No. 4262129, apparatuses or systems for providing localized weather information based on weather data that is acquired using means such as sensors have been proposed.

However, the number of occurrences of the local weather fluctuations that cause extensive damages, such as severe local rain and tornado, is increased, and it is required to pinpointly predict the occurrence position. It is known that the weather fluctuation such as severe local rain or tornado occurs due to a rapid development of cumulonimbus cloud. FIGS. 13A to 13F are schematic diagrams illustrating a severe local rain occurrence mechanism. FIGS. 13A to 13C show a development stage in which cumulonimbus cloud that is called a storm cell is developed in a manner that wind including moist air reaches a building or the like to generate updraft, or near-surface air becomes warm to generate updraft. FIGS. 13D to 13E show a maturity stage in which sufficiently grown raindrops fall to the ground to become severe rain, and downdraft is generated. FIG. 13F shows a decay stage in which the downdraft becomes stronger than the updraft, and the storm cell gets towards convergence. It may take a short time of about 30 minutes from the start of development of the cumulonimbus cloud as shown in FIG. 13A to the occurrence of the severe local rain as shown in FIG. 13D.

The apparatuses or systems described in the above-described patent documents acquire data regarding weather using means such as sensors or the like, but an effective proposal has not been made regarding how to predict the weather fluctuations that occur locally and disappear over a short time, such as severe local rain or tornado.

It may be thought that it is not impossible to predict severe local rain using a radar or a lidar that can acquire raindrops. A mass of raindrops occurs in the state illustrated in FIGS. 13B or 13C and even if raindrops can be captured at this time point, severe local rain may have been generated about 10 minutes from that time point, and therefore this may not be an efficient prediction method.

### SUMMARY

An advantage of some aspects of the invention is to provide a system for providing weather fluctuation prediction information and a method of providing weather fluctuation prediction information, which can provide information to predict specific weather fluctuations that occur locally and disappear quickly.

(1) An aspect of the invention is directed to a system for providing weather fluctuation prediction information which provides information to predict specific weather fluctuations that occur due to changes in atmospheric pressure in a specific local area, which includes at least one atmospheric pressure measurement device arranged in the specific area; and a data processing device processing atmospheric pressure data measured by the atmospheric pressure measurement device, wherein the atmospheric pressure measurement device includes an atmospheric pressure sensor having a pressure sensing device that changes a resonance frequency according to the atmospheric pressure and outputting the atmospheric pressure data according to an oscillation frequency of the corresponding pressure sensing device, and the data processing device includes an atmospheric pressure data acquisition unit continuously acquiring the atmospheric pressure data measured by the atmospheric pressure measurement device and a weather fluctuation prediction information generation unit generating the information to predict the weather fluctuation based on the atmospheric pressure data acquired by the atmospheric pressure data acquisition unit.

The specific weather fluctuations, for example, may be a thunderstorm, severe local rain, a tornado, or downburst, which occur due to the occurrence of localized low atmospheric pressure.

In general, the resolution of a barometer that is used for weather observation is in the hPa order, whereas the frequency change type atmospheric pressure sensor measures the oscillation frequency of the pressure sensing device with a high frequency clock signal, and thus can obtain the measurement resolution in the Pa order relatively easily. According to the aspect of the invention, by using the high-resolution frequency change type atmospheric pressure sensor, slight changes in atmospheric pressure over a short time are grasped, and thus information to predict the specific weather fluctuations that occur locally and disappear quickly (for example, severe rain or a tornado that occurs due to the localized low atmospheric pressure) can be provided. Further, by detecting whether the atmospheric pressure gradually changes or abruptly changes, the atmospheric pressure change amount, and the atmospheric pressure change state at high accuracy, the information to predict the weather fluctuation (for example, severe local rain or a tornado that occurs due to the localized low atmospheric pressure) can be provided. By analyzing this information, the specific weather fluctuation can be predicted at high accuracy.

(2) In the system for providing weather fluctuation prediction information, the plurality of the atmospheric pressure measurement devices may be arranged in a mesh shape.

Thus, more detailed information can be generated through acquiring of the atmospheric pressure data in many detailed positions of the specific local area.

(3) In the system for providing weather fluctuation prediction information, the plurality of the atmospheric pressure measurement devices may be arranged with a density which is determined based on a specific standard that is related to the characteristic of the specific area.

Thus, the number of the atmospheric pressure measurement devices to be arranged can be optimized according to the characteristic of the specific area.

(4) In the system for providing weather fluctuation prediction information, at least some of the plurality of the atmospheric pressure measurement devices may be arranged in positions having different altitudes.

Thus, more detailed information that takes into account atmospheric pressure change in a height direction can be generated.

(5) In the system for providing weather fluctuation prediction information, the atmospheric pressure measurement device may be arranged at a fixed point that does not move with respect to a ground surface.

(6) In the system for providing weather fluctuation prediction information, the weather fluctuation prediction information generation unit may generate time series of image data that expresses atmospheric pressure distribution in the specific area with colors according to the atmospheric pressure as information to predict the weather fluctuations.

The time series of the image data that is generated by an atmospheric pressure distribution image generation unit may be displayed on a display unit or may be transmitted to an external device such as a portable terminal.

Thus, the temporal change of the atmospheric pressure distribution in the specific area can be visually grasped.

(7) In the system for providing weather fluctuation prediction information, the data processing device may further include a weather fluctuation prediction unit determining whether or not a specific determination standard is satisfied based on the information to predict the weather fluctuation and predicting the occurrence of the weather fluctuation based on the result of determination.

Thus, the prediction of the weather fluctuation can be automated.

(8) In the system for providing weather fluctuation prediction information, the weather fluctuation prediction unit may predict that the weather fluctuations occur within a predetermined time if a lowering amount of the atmospheric pressure at a specified time in the position of the atmospheric pressure measurement device is larger than a predetermined threshold value.

Thus, the occurrence of localized low atmospheric pressure can be grasped, and thus the occurrence of the weather fluctuation due to the low atmospheric pressure can be predicted.

(9) In the system for providing weather fluctuation prediction information, the weather fluctuation prediction unit may predict at least one of a weather fluctuation occurrence position and an occurrence time based on the temporal change of the atmospheric pressure in the position of the atmospheric pressure measurement device.

Thus, the weather fluctuation occurrence position or the occurrence time due to the localized low atmospheric pressure can be predicted.

(10) In the system for providing weather fluctuation prediction information, the pressure sensing device provided in the atmospheric pressure sensor may be a piezoelectric double-ended tuning fork resonator.

By using the piezoelectric double-ended tuning fork resonator, an atmospheric pressure sensor having much higher resolution can be realized.

(11) Another aspect of the invention is directed to a method of providing weather fluctuation prediction information which provides information to predict specific weather fluctuations that occur due to the change in atmospheric pressure in a specific local area, which includes measuring atmospheric pressure using at least one atmospheric pressure measurement device which is arranged in the specific area, and includes an atmospheric pressure sensor having a pressure sensing device that changes a resonance frequency according to the atmospheric pressure and outputting the atmospheric pressure data according to an oscillation frequency of the corresponding pressure sensing device; continuously acquiring the atmospheric pressure data measured by the atmospheric pressure measurement device; and generating the information to predict the weather fluctuation based on the atmospheric pressure data acquired in the acquiring of the atmospheric pressure data.

### BRIEF DESCRIPTION OF THE DRAWINGS

The invention will be described with reference to the accompanying drawings, wherein like numbers reference like elements.

FIG. 1 is a diagram illustrating the configuration example of an atmospheric pressure sensor according to an embodiment of the invention.

FIG. 2 is a schematic view of a cross section of a pressure sensor device according to the embodiment of the invention.

FIG. 3 is a schematic view of a cross section of a pressure sensor device according to the embodiment of the invention.

FIG. 4 is a bottom view schematically illustrating a vibration piece and a diaphragm according to the embodiment of the invention.

FIG. 5 is a diagram illustrating the configuration of a system for providing weather fluctuation prediction information according to the embodiment of the invention.

FIG. 6 is a diagram illustrating an arrangement example of an atmospheric pressure measurement device.

FIG. 7 is a diagram schematically illustrating an example of an atmospheric pressure distribution image.

FIG. 8 is a diagram illustrating an example of a prediction determination table.

FIG. 9 is a diagram illustrating observation data.

FIG. 10 is a diagram explaining prediction of a weather fluctuation occurrence position and occurrence time.

FIG. 11 is a flowchart illustrating an example of processes of a system for providing weather fluctuation prediction information.

FIG. 12 is a diagram illustrating an arrangement example of an atmospheric pressure measurement device.

FIGS. 13A to 13F are schematic diagrams illustrating a severe local rain occurrence mechanism.

### DESCRIPTION OF EXEMPLARY EMBODIMENTS

Hereinafter, embodiments of the invention will be described in detail with reference to the accompanying drawings. The embodiments to be described hereinafter do not unreasonably limit the features of the invention described in the appended claims. Further, all configurations to be described hereinafter may not be required configurations.

### 1. Configuration of an Atmospheric Pressure Sensor

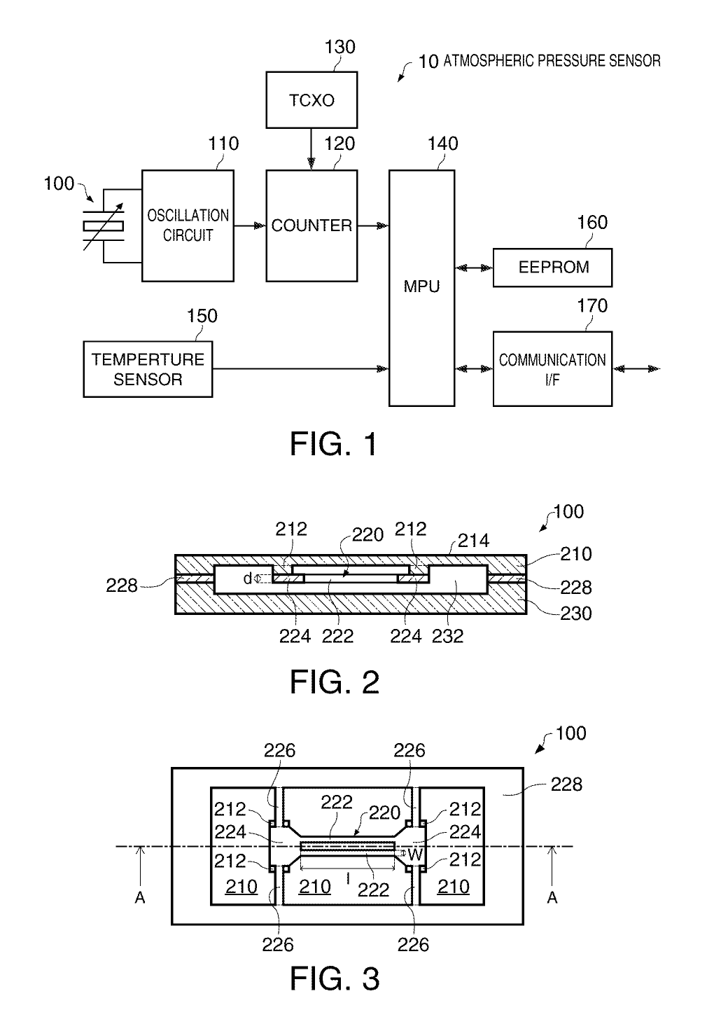

FIG. 1 is a diagram illustrating the configuration example of an atmospheric pressure sensor that is used in a system for providing weather fluctuation prediction information according to an embodiment of the invention. The atmospheric pressure sensor according to the embodiment of the invention may be configured by omitting some of the constituent elements (units) of FIG. 1 or adding other constituent elements thereto.

The atmospheric pressure sensor 10 according to the embodiment of the invention includes a pressure sensor device 100, an oscillation circuit 110, a counter 120, a TCXO (Temperature Compensated Crystal Oscillator) 130, an MPU (Micro Processing Unit) 140, a temperature sensor 150, an EEPROM (Electrically Erasable Programmable Read Only Memory) 160, and a communication interface (I/F) 170.

The pressure sensor device 100 has a pressure sensing device of a type using the change of a resonance frequency of a vibration piece (vibration type). The pressure sensing device, for example, is a piezoelectric resonator that is formed of a piezoelectric material, such as quartz crystal, lithium niobate, lithium tantalite, or the like, and for example, a tuning fork resonator, a double-ended tuning fork resonator, an AT resonator (thickness-shear mode resonator), or an SAW resonator may be applied thereto.

In particular, since the piezoelectric double-ended tuning fork resonator has a very large change in resonant frequency for extensive and compressive stresses and a large variable width of the resonant frequency in comparison to the AT resonator (thickness-shear mode resonator) or the like, a high-resolution atmospheric pressure sensor that can detect a slight pressure difference can be realized by using a piezoelectric double-ended tuning fork resonator as a pressure sensing device. Accordingly, the atmospheric pressure sensor 10 according to the embodiment of the invention uses the piezoelectric double-ended tuning fork resonator as the pressure sensing device. In this case, by selecting quartz crystal having a high Q value and superior temperature stability as a piezoelectric material, the superior stability, the highest level of resolution and accuracy can be realized.

FIG. 2 is a schematic view of a cross section of a pressure sensor device 100 according to the embodiment of the invention. FIG. 3 is a bottom view schematically illustrating a vibration piece 220 and a diaphragm 210 of the pressure sensor device 100 according to the embodiment of the invention. In FIG. 3, a base 230 that is a sealing plate is omitted. FIG. 2 corresponds to the cross section taken along line A-A of FIG. 3.

The pressure sensor device 100 includes the diaphragm 210, the vibration piece 220, and the base 230 as the sealing plate.

The diaphragm 210 is a flat plate member having a flexible portion that is bent by pressure received therein. The outer surface of the diaphragm 210 is a pressure receiving surface 214, and a pair of protrusions 212 are formed on the opposite surface of the pressure receiving surface 214.

The vibration piece 220 has a vibration beam 222 and a pair of base portions 224 formed at both ends of the vibration beam 222. The vibration beam 222 is in the form of a both-side support beam between the pair of base portions 224. The pair of base portions 224 are fixed to a pair of protrusions 212 formed on the diaphragm 210. An electrode (not illustrated) is appropriately installed on the vibration beam 222, and by supplying a drive signal from the electrode, the vibration beam 222 is bending-vibrated with a certain resonance frequency. The vibration piece 220 is formed of a material having piezoelectricity. The material of the vibration piece 220 may be a piezoelectric material such as quartz crystal, lithium tantalite, lithium niobate, or the like. The vibration piece 220 is supported on a frame portion 228 by a support beam 226.

The base 230 is bonded with the diaphragm 210, and a cavity 232 is formed between the base 230 and the diaphragm 210. By making the cavity 232 as a vacuum space, the Q value of the vibration piece 220 can be heightened (the CI value can be lowered).

In the pressure sensor device 100 having the above-described structure, the diaphragm 210 is bent and deformed when pressure is applied to the pressure receiving surface 214. In this case, since the pair of base portions 224 of the vibration piece 220 are fixed to the pair of protrusions 212 of the diaphragm 210, the gap between the base portions 224 is changed as the diaphragm 210 is deformed. That is, when pressure is applied to the pressure sensor device 100, tensile or compressive stress occurs in the vibration beam 222.

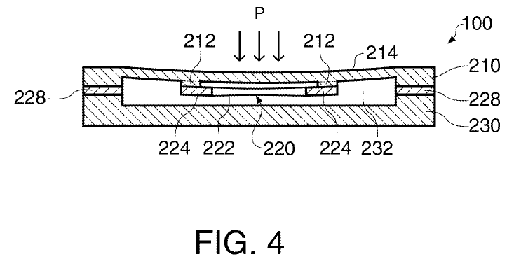

FIG. 4 is a schematic view of a cross section of the pressure sensor device 100, and shows the state where the diaphragm 210 is deformed by pressure P. FIG. 4 illustrates an example of a convex deformation of the diaphragm 210 toward an inner side of the device when force (pressure P) is applied from the outer side to the inner side of the pressure sensor device 100. In this case, the gap between the pair of protrusions 212 becomes bigger. On the other hand, although not illustrated, if force is applied from the inner side to the outer side of the pressure sensor device 100, convex deformation of the diaphragm 210 toward an outer side of the pressure sensor device occurs, and thus the gap between the pair of protrusions 212 becomes smaller. Accordingly, tensile or compressive stress occurs in a direction that is parallel to the vibration beam 222 of the vibration piece 220 of which the both ends are fixed to the pair of protrusions 212. That is, the pressure applied in the vertical direction to the pressure receiving surface 214 is converted into the stress in the linear direction that is parallel to the vibration beam 222 of the vibration piece 220 through the protrusions (support portions) 212.

The resonance frequency of the vibration beam 222 may be analyzed as follows. As illustrated in FIGS. 2 and 3, if it is assumed that the length of the vibration beam 222 is l, the width thereof is w, and the thickness thereof is d, a motion equation when an external force F is applied in the direction of the long side of the vibration beam 222 is approximated by Equation (1) below.

$$EI \frac{{\partial }^{4} y}{\partial {x}^{4}} + \frac{ρ A}{g} \frac{{\partial }^{2} y}{\partial {t}^{2}} + F \frac{{\partial }^{2} y}{\partial {x}^{2}} = 0 \qquad ( 1 )$$

In Equation (1), E denotes a longitudinal elastic constant (Young's modulus), ρ denotes density, A denotes a cross-sectional area of the vibration beam (=w·d), g is a gravitational acceleration, F denotes an external force, y denotes a displacement, and x denotes a certain position of the vibration beam.

By solving Equation (1) by giving a general solution and boundary conditions thereto, Equation (2) of the resonance frequency in the case of no external force is obtained as follows.

$${f}_{0} = \frac{{( λ l )}^{2}}{2 π {l}^{2}} \sqrt{\frac{El \cdot g}{ρ A}} \qquad ( 2 )$$

If it is assumed that the area moment of inertia I is I=dw³/12, the cross-sectional area A is A=dw, and λI=4.73, Equation (2) may be modified as in Equation (3) below.

$${f}_{0} = \frac{{( 4.73 )}^{2}}{2 π} \sqrt{\frac{Eg}{12 ρ}} \frac{w}{{l}^{2}} \qquad ( 3 )$$

Accordingly, the resonance frequency f₀ when the external force F is F=0 is in proportion to the width w of the beam, and is in reverse proportion to the square of the length 1.

By obtaining the resonance frequency f_{F} in the same procedure when the external force F is applied to two vibration beams, Equation (4) below is obtained.

$${f}_{F} = {f}_{0} \sqrt{1 - K \frac{{l}^{2}}{EI} \frac{F}{2}} \qquad ( 4 )$$

In the case where the area moment of inertia I is I=dw³/12, Equation (4) can be modified as in Equation (5) below.

f_{F}=f₀\sqrt{1−S_{F}·σ} (5)

In Equation (5), S_{F} denotes a stress sensitivity (=K·12/E·(1/w)²), and σ denotes a stress (=F/(2A)).

As described above, under the assumption that the force F that is applied to the pressure sensor device 100 in the compression direction is negative, and the force F that is applied to the pressure sensor device 100 in the extension direction is positive, if the force F is applied in the compression direction, the resonance frequency f_{F} is decreased, while if the force F is applied in the extension direction, the resonance frequency f_{F} is increased.

Then, by correcting a linearity error that is caused by the pressure-frequency characteristic and the temperature-frequency characteristic of the pressure sensor device 100 by using a polynomial as indicated in Equation (6) below, high-resolution and high-precision pressure value P can be obtained.

P=α(t)fₙ³+β(t)fₙ²+γ(t)fₙ+δ(t) (6)

In Equation (6), fₙ denotes a sensor normalization frequency, and is expressed by fₙ=(f_{F}/f₀)². Further, t denotes temperature, and α(t), β(t), γ(t), and δ(t) are expressed by Equations (7) to (10) below.

α(t)=αt³+bt²+ct+d (7)

β(t)=et³+ft²+gt+h (8)

γ(t)=it³+jt²+kt+l (9)

δ(t)=mt³+nt²+ot+p (10)

In Equations (7) to (10), a to p are correction coefficients.

That is, by measuring the frequency of an output signal of the pressure sensor device 100, the vibration frequency of the vibration beam 220 (the resonance frequency f_{F} when the force F is applied) is obtained, and by using the pre-measured resonance frequency f₀ or the correction coefficients a to p, the pressure P is calculated from Equation (6).

Referring again to FIG. 1, the oscillation circuit 110 outputs an oscillation signal that is obtained by oscillating the vibration beam 222 of the pressure sensor device 100 with the resonance frequency.

The counter 120 is a reciprocal counter that counts a specific period of the oscillation signal that is output from the oscillation circuit 110 by a high-precision clock signal that is output from the TCXO 130. However, the counter 120 may be configured as a direct count type frequency counter (direct counter) that counts the number of pulses of the oscillation signal of the pressure sensor device 100 in a specific gate time.

The MPU (Micro Processing Unit) 140 calculates the pressure value P from the counted value of the counter 120. Specifically, the MPU 140 calculates the temperature t from the detected value of the temperature sensor 150, and calculates α(t), β(t), γ(t), and δ(t) in Equations (7) to (10) using the correction coefficient values of a to p which are pre-stored in the EEPROM 160. Further, the MPU 140 calculates the pressure value P in Equation (6) using the counted value of the counter 120 and the resonance frequency f₀ pre-stored in the EEPROM 160. Further, the pressure value P calculated by the MPU is output to the outside of the atmospheric pressure sensor 10 through the communication interface 170.

According to the frequency change type atmospheric pressure sensor 10 as constructed above, since the counter 120 counts the oscillation frequency of the pressure sensor device 100 by the high-precision and high-frequency (for example, several tens of MHz) clock signal that is output from the TCXO 130, and the MPU 140 performs calculation of the pressure value and correction of the linearity error through digital processing, a high-resolution or high-accuracy pressure value (atmospheric pressure data) that is equal to or less than the Pa order can be obtained. Further, since the atmospheric pressure sensor 10 can update the atmospheric pressure data in a period of a second order even in consideration of the counting time, even slight change in atmospheric pressure can be grasped over a short time, and thus it is suitable to the real-time measurement of atmospheric pressure.

In the embodiment and in FIG. 1, it is exemplified that the oscillation circuit that is a reference clock source is the TCXO 130. However, the oscillation circuit may be configured, for example, by a crystal oscillation circuit having an AT-cut quartz crystal resonator mounted thereon, which has no temperature compensation circuit. In this case, since the oscillation circuit has no temperature compensation circuit, the detection precision of the atmospheric pressure change is lowered, and a designer may appropriately select whether the reference clock source is implemented by the corresponding crystal oscillation circuit or the TCXO 130 according to the cost or prediction precision of the prediction system.

### 2. Configuration of a System for Providing Weather Fluctuation Prediction Information

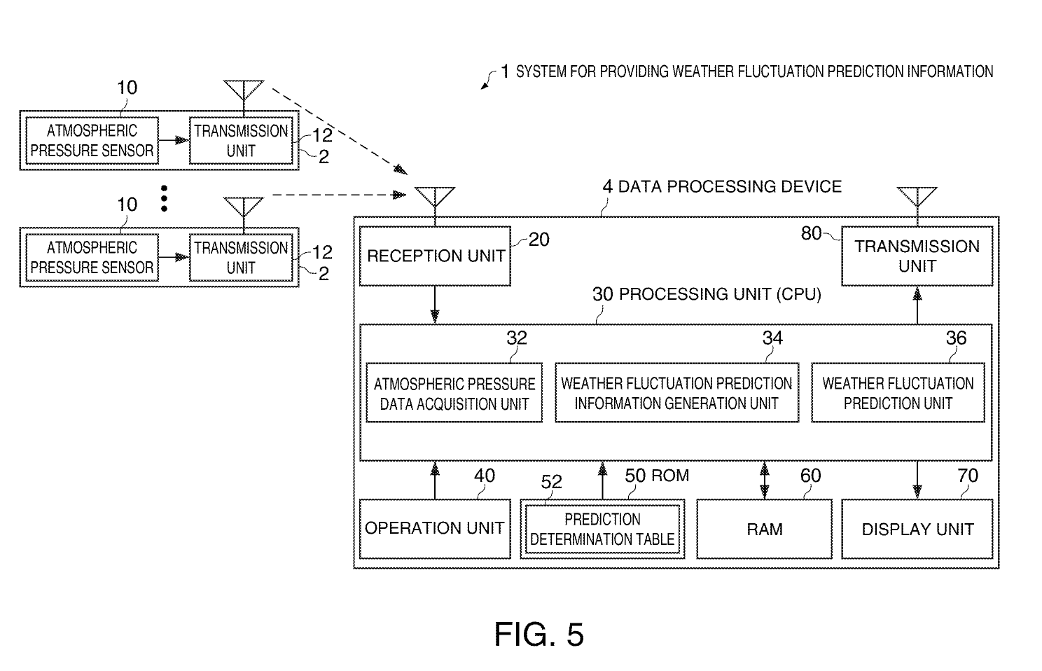

FIG. 5 is a diagram illustrating the configuration of a system for providing weather fluctuation prediction information according to the embodiment of the invention. The system for providing weather fluctuation prediction information according to the embodiment of the invention may be configured by omitting some of the constituent elements (units) of FIG. 5 or adding other constituent elements thereto.

The system 1 for providing weather fluctuation prediction information according to the embodiment of the invention includes an atmospheric pressure measurement device 2 and a data processing device 4, and provides information for predicting a specific weather fluctuation that occurs due to the change of the atmospheric pressure in a specific local area (hereinafter referred to as “weather fluctuation prediction information”).

The atmospheric pressure measurement device 2 includes an atmospheric pressure sensor 10 and a transmission unit 12.

The atmospheric pressure sensor 10 is a frequency change type sensor which has a pressure sensing device that changes the resonance frequency according to the atmospheric pressure and outputs data according to the oscillation frequency of the corresponding pressure sensing device. Specifically, the atmospheric pressure sensor 10, for example, is a high-resolution and high-precision sensor which has a configuration as illustrated in FIG. 1 and can grasp the weather fluctuation that is equal to or less than the Pa order in the period of a second order by measuring the oscillation frequency of the pressure sensing device by a high-frequency clock signal.

The transmission unit 12 transmits the atmospheric pressure data that is measured by the atmospheric pressure sensor 10 in real time in the period of the second order with radio waves having frequencies allocated to the respective atmospheric pressure measurement devices 2. The respective atmospheric pressure measurement devices 2 are allocated with different transmission frequencies.

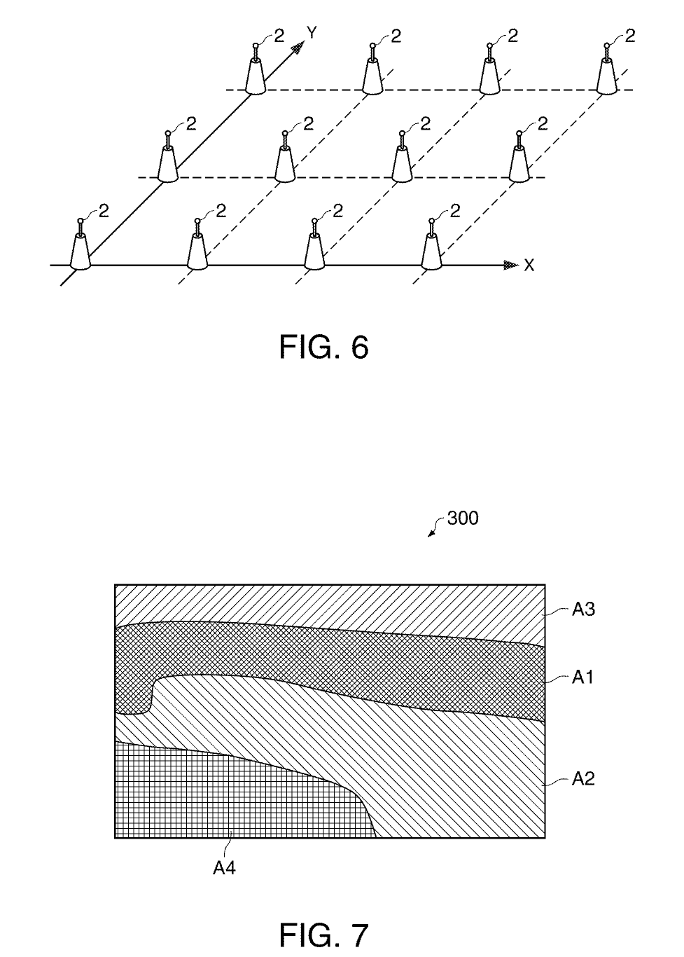

In this embodiment, an area that is narrow enough to fit a circle having a diameter of several km to several tens of km is determined as a specific area to be observed, and for example, as illustrated in FIG. 6, a plurality of atmospheric pressure measurement devices 2 are fixedly arranged in a two-dimensional mesh shape on an almost horizontal XY plane in the corresponding specific area to form a fine observation mesh. The length of one side of the observation mesh (the distance between the atmospheric pressure measurement devices) is set to about several hundreds of m to several km. However, the distances between the atmospheric pressure measurement devices may not be fixed. That is, the observation mesh may not have a fixed size, and for example, it is considered that the atmospheric pressure measurement device 2 is installed in a base station of a mobile phone, a convenience store, a smart grid electricity meter, or the like.

The distance between the atmospheric pressure measurement devices (the size of the observation mesh) may be determined based on a specified standard that is related to the characteristics of a specific area. Here, the characteristics of the specific area may be, for example, the population density, the density condition of buildings, the topography, and the like. For example, in urban areas having high population density, the damage caused by the severe local rain or the like may become great, and in areas where buildings stand close together or the ground is covered with concrete, the weather fluctuation is liable to occur. Further, in a piedmont area, the landslide damage due to severe local rain or the like may occur. Because of this, in the above-described areas, the distance between the atmospheric pressure measurement devices may be narrowed in order to heighten the prediction precision of the weather fluctuation. That is, based on the specified standard that is related to the characteristics of the specific area, the density of the atmospheric pressure measurement devices 2 may be determined.

Further, in consideration of a pressure-gradient force (an example of the characteristics of the specific area) as an index, the density of the atmospheric pressure measurement devices 2 may be changed. Since the atmospheric pressure difference becomes greater as the pressure-gradient force becomes larger, for example, the density of the atmospheric pressure measurement devices 2 may be heightened as in an area where the pressure-gradient force is large, while the density of the atmospheric pressure measurement devices 2 may be lowered as in an area where the pressure-gradient force is small.

As described above, by changing the density of the atmospheric pressure measurement devices 2 according to the characteristics of the specific area, the number of atmospheric pressure measurement devices to be used can be optimized.

In this embodiment of the invention, although the plurality of atmospheric pressure measurement devices 2 are installed in the specific area, the configuration in which at least one atmospheric pressure measurement device 2 is installed is included in the scope of the invention.

The data processing device 4 includes a reception unit 20, a processing unit (CPU (Central Processing Unit)) 30, an operation unit 40, a ROM 50, a RAM 60, a display unit 70, and a transmission unit 80.

The reception unit 20 receives the transmitted data from the respective atmospheric pressure measurement devices 2 as performing switching in a predetermined period so that the received frequencies become the transmitted frequencies allocated in order to the atmospheric pressure measurement devices 2, and demodulates the respective atmospheric pressure data. Further, the reception unit 20 sends the demodulated atmospheric pressure data to the processing unit 30.

In this case, transmission units 12 of the respective atmospheric pressure measurement devices 2 transmit the atmospheric pressure data in time division in predetermined different periodic timing using the radio waves having the same transmission frequency, and the reception unit 20 of the data processing device 4 receives the atmospheric pressure data in time division in synchronization with the transmission timing of the respective atmospheric measurement devices 2.

The processing unit 30 performs various kinds of calculation processes or control processes according to programs stored in the ROM 50. Specifically, the processing unit 30 receives the atmospheric pressure data from the reception unit 20, and performs various kinds of calculation processes. Specifically, the processing unit 30 performs various kinds of processes according to an operation signal from the operation unit 40, a process of displaying various kinds of information on the display unit 70, and a process of controlling data communication with an external device such as a mobile terminal through the reception unit 20 and the transmission unit 80.

Particularly, in this embodiment, the processing unit 30 includes an atmospheric pressure data acquisition unit 32, a weather fluctuation prediction information generation unit 34, and a weather fluctuation prediction unit 36.

The atmospheric pressure data acquisition unit 32 continuously acquires the atmospheric pressure data that is sent from the reception unit 20 in correspondence to identification IDs of the atmospheric pressure measurement devices 2. Specifically, the atmospheric pressure data acquisition unit 32 receives and stores the respective atmospheric pressure data in the RAM 60 in order in correspondence to the identification IDs allocated to the atmospheric pressure measurement devices 2.

The weather fluctuation prediction information generation unit 34 generates the weather fluctuation prediction information in a specific area based on the atmospheric pressure data acquired by the atmospheric pressure data acquisition unit 32. For example, the weather fluctuation prediction information generation unit 34 may generate graph data that indicates the temporal change of the atmospheric pressure value in a predetermined position (an example of the weather fluctuation prediction information), or may generate time series of the image data that represents the atmospheric pressure distribution in the specific area with different colors depending on the atmospheric pressure (an example of the weather fluctuation prediction information). For example, in the same manner as a thermographic image in which a higher-temperature portion becomes reddish and a lower-temperature portion becomes bluish, the atmospheric pressure distribution image is generated in a manner that a higher-pressure portion becomes reddish and a lower-pressure portion becomes bluish. FIG. 7 is a diagram schematically illustrating an example of an atmospheric pressure distribution image. In FIG. 7, for example, an area A1 having a relatively high atmospheric pressure appears reddish. Further, for example, an area A2 having a relatively low atmospheric pressure appears bluish. Further, for example, an area A3 or an area A4 has an intermediate atmospheric pressure that is between the areas A1 and A2, and appears with a color between red and blue (greenish or the like). Although FIG. 7 illustrates a simplified atmospheric pressure distribution image, it is preferable, in practice, to change the colors by the resolution according to the measurement resolution of the atmospheric pressure sensor 10 for each area having a size of the observation mesh or a smaller size. As described above, by showing an image in which the atmospheric pressure distribution of the specific local areas is divided by colors, the temporal change of the atmospheric pressure can be visually grasped, and can be efficiently used as information for predicting the weather fluctuation. For example, by monitoring the atmospheric pressure distribution image, how the localized low pressure that causes the occurrence of the severe local rain or tornado moves can be accurately grasped.

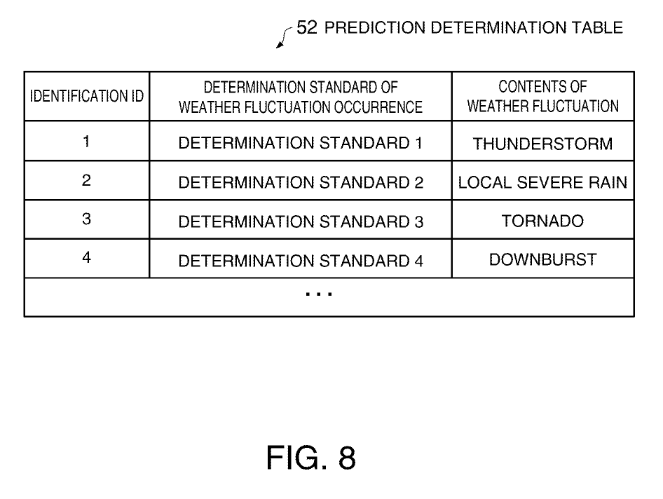

The weather fluctuation prediction unit 36 predicts the specified weather fluctuations (a thunderstorm, severe local rain, a tornado, downburst, and the like) in a specific area based on the weather fluctuation prediction information generated by the weather fluctuation prediction information generation unit 34. Specifically, for example, as illustrated in FIG. 8, a prediction determination table 52, in which the weather fluctuations to be predicted, such as a thunderstorm, severe local rain, a tornado, downburst, and the like, correspond to identification IDs and determination standards for determining the occurrence of the respective weather fluctuations, is stored in the ROM 50. The determination standard includes at least a standard related to the atmospheric pressure, and may further include a standard related to a temperature or humidity. Further, the weather fluctuation prediction unit 36 determines whether the respective determination standards are satisfied based on the weather fluctuation prediction information with reference to the prediction determination table 52, and predicts that the weather fluctuation that satisfies the determination standard occurs.

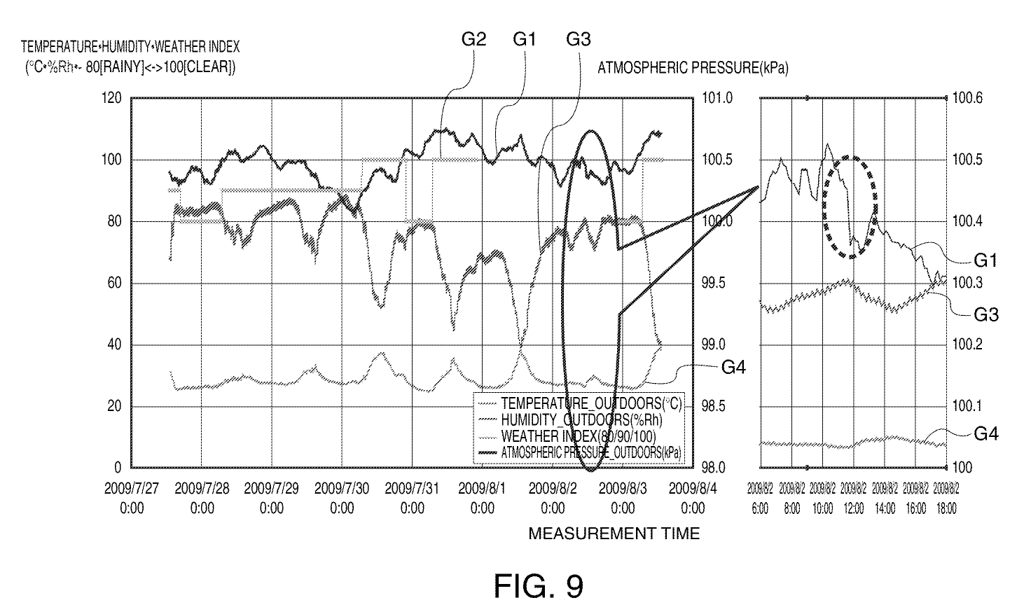

Further, the weather fluctuation prediction unit 36 may calculate the amount of change in atmospheric pressure for a predetermined time in respective positions of the atmospheric pressure measurement device 2, and may predict the occurrence of the specified weather fluctuation in the specific area based on the result of calculation. For example, the weather fluctuation prediction unit 36 may compare the amount of change in atmospheric pressure for a predetermined time with a predetermined threshold value, and may predict the occurrence of the weather fluctuation based on the result of comparison. More specifically, if the lowering amount of the atmospheric pressure at a specified time in the respective positions of the atmospheric pressure measurement device 2 is larger than the predetermined threshold value, the weather fluctuation prediction unit 36 may determine that a local (small) low pressure according to an abrupt updraft occurs, and predict that the weather fluctuations such as a thunderstorm or severe local rain will occur in a predetermined time (for example, in several minutes to several tens of minutes). For example, FIG. 9 is a diagram illustrating actual observation data obtained by observing a temperature (G4), humidity (G3), atmospheric pressure (G1), and weather index (G2) in a certain place. In the left graph of FIG. 9, the horizontal axis represents a measurement time, the vertical axis (left side) represents a temperature (° C.), humidity (% Rh), and weather index (80 [rainy] to 100 [clear], and the vertical axis (right side) represents atmospheric pressure (kPa). In particular, the atmospheric pressure data (G1) is measured by the atmospheric pressure sensor 10 according to this embodiment, which can capture the change of the atmospheric pressure with high resolution that is equal to or less than the Pa order. The right graph of FIG. 9 shows a zoomed portion in a period of 6:00 to 18:00 on Aug. 2, 2009 in the left graph. The portion surrounded by a dashed line shows that the atmospheric pressure is abruptly lowered by about 1 hPa in about one hour. It is confirmed that a thunderstorm occurs after the abrupt lowering of the atmospheric pressure starts. That is, it is considered that the abrupt lowering of the atmospheric pressure is related to the occurrence of the updraft in the development stage of cumulonimbus cloud. Accordingly, for example, by determining the lowering amount of the atmospheric pressure at a specified time, which is larger than the predetermined threshold value, as the determination standard, whether or not the weather fluctuation according to the development of the cumulonimbus cloud occurs can be predicted. However, in order to increase the prediction precision, prediction may be performed in consideration of the atmospheric pressure data as a base and taking into account data except for the atmospheric pressure (temperature or humidity data).

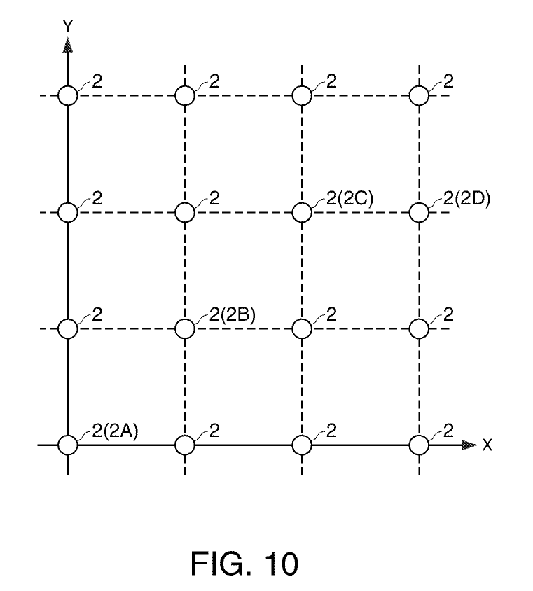

Further, the weather fluctuation prediction unit 36 may predict at least one of the occurrence position and the occurrence time of the weather fluctuation based on the temporal change of the atmospheric pressure in the position of the atmospheric pressure measurement device 2. For example, as illustrated in FIG. 10, if the lowering amount of the atmospheric pressure in the position of the atmospheric pressure measurement device 2A exceeds the threshold value at time T1 in the case where a plurality of atmospheric pressure measurement devices 2 are arranged in a mesh shape at intervals of several hundreds of m to several km, it may be guessed that localized low pressure according to an abrupt updraft occurs in the neighborhood of an atmospheric pressure measurement device 2A at about time T1. Then, if it is assumed that at time T2, the atmospheric pressure is lowered in the position of an atmospheric pressure measurement device 2B, at time T3, the atmospheric pressure is lowered in the position of an atmospheric pressure measurement device 2C, and at time T4, the atmospheric pressure is lowered in the position of an atmospheric pressure measurement device 2D, it may be guessed that localized low pressure that occurs in the neighborhood of the atmospheric pressure measurement device 2A moves in the neighborhood of the atmospheric pressure measurement devices 2B, 2C, and 2D. Accordingly, from the elapsed time after the occurrence of the localized low pressure and the movement path of the low pressure, the position and time, where the weather fluctuation such as a thunderstorm or the like occurs, can be predicted.

In this case, if it is sufficient that the system for providing weather fluctuation prediction information according to this embodiment provides the weather fluctuation prediction information, the weather fluctuation prediction unit 36 may not be an essential constituent element of the processing unit 30.

The operation unit 40 is an input device that is composed of operation keys or button switches, and outputs an operation signal according to a user's operation to the processing unit 30.

The ROM 50 stores programs or data for the processing unit 30 to perform various kinds of calculations or control processes. In particular, the ROM 50 according to this embodiment stores the above-described prediction determination table 52.

The RAM 60 is used as a work area of the processing unit 30, and temporarily stores a program or data read from the ROM 50, data input from the operation unit 40, and the results of operations that are executed by the processing unit 30 according to various kinds of programs.

The display unit 70 is a display device that is composed of an LCD (Liquid Crystal Display) or the like, and displays various kinds of information based on a display signal input from the processing unit 30. On the display unit 70, for example, respective frames of an atmospheric pressure distribution image that is divided by colors are displayed.

The transmission unit 80 performs transmission of information generated by the processing unit 30 to an external device. For example, the weather fluctuation prediction information generated by the weather fluctuation prediction information generation unit 34 or information predicted by the weather fluctuation prediction unit 36 may be transmitted to a mobile terminal or the like through the transmission unit 80.

### 3. Processing of the System for Providing Weather Fluctuation Prediction Information

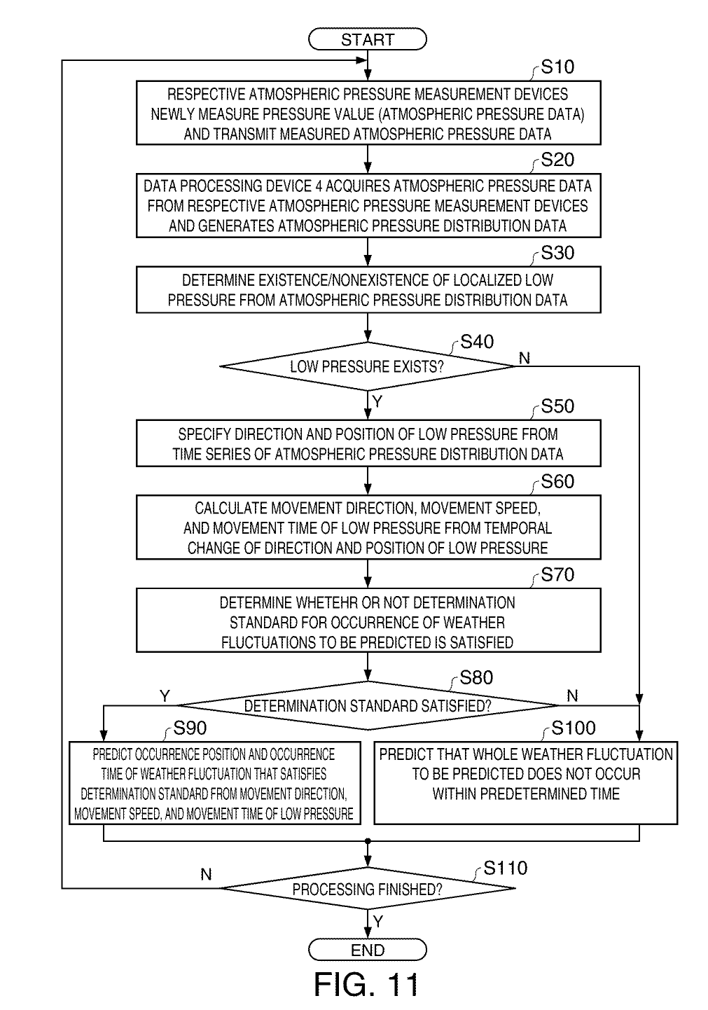

FIG. 11 is a flowchart illustrating an example of processes of a system for providing weather fluctuation prediction information.

First, the respective atmospheric pressure measurement devices 2 newly measure pressure values (atmospheric pressure data) and transmit the measured atmospheric pressure data (step S10).

Then, the data processing device 4 acquires the atmospheric pressure data from the respective atmospheric pressure measurement devices 2 through the atmospheric pressure data acquisition unit 32, and generates atmospheric pressure distribution data through the weather fluctuation prediction information generation unit 34 (step S20).

Then, the weather fluctuation prediction information generation unit 34 determines existence/nonexistence of the localized low pressure from the atmospheric pressure distribution data generated in step S20 (step S30).

If it is determined that the low pressure does not exist (“N” in step S40), the weather fluctuation prediction unit 36 predicts that the weather fluctuation to be predicted does not occur within a predetermined time (step S100).

On the other hand, if it is determined that the low pressure exists (“Y” in step S40), the weather fluctuation prediction information generation unit 34 specifies the direction and the position of the low pressure from the time series (temporal change of the atmospheric pressure) of the atmospheric pressure distribution data generated up to now (step S50).

Then, the weather fluctuation prediction information generation unit 34 calculates the movement direction, movement speed, movement time, and the like, of the low pressure from the temporal change of the direction and the position of the low pressure obtained up to now (step S60).

Then, weather fluctuation prediction unit 36 determines whether the determination standard (the determination standard set in the prediction determination table 52) for the occurrence of the weather fluctuations to be predicted based on the various kinds of the information obtained from the time series of the atmospheric pressure distribution data (step S70).

If at least one determination standard is satisfied “Y” in step S80), the weather fluctuation prediction unit 36 predicts the occurrence position and the occurrence time of the weather fluctuation that satisfies the determination standard from the movement direction, movement speed, movement time of the low pressure calculated in step S60 (step S90).

On the other hand, if none of the determination standards is satisfied (“N” in step S80), the weather fluctuation prediction unit 36 predicts that none of the weather fluctuations to be predicted occurs within a predetermined time (step S100).

Then, until the process is finished (“Y” in step S110), processes in steps S10 to S100 are repeatedly performed.

As described above, according to the system for providing weather fluctuation prediction information according to this embodiment, the weather fluctuation prediction information can be provided by grasping a slight atmospheric pressure fluctuation over a short time using the high-resolution frequency change type atmospheric pressure sensor 10 of the Pa order. Further, by analyzing the weather fluctuation prediction information, the specified weather fluctuation can be predicted with good precision.

Further, according to this embodiment, the occurrence of the localized low pressure can be grasped, and thus the occurrence of the weather fluctuation due to the low pressure can be predicted. Further, by calculating the movement path of the low pressure from the weather fluctuation information, the occurrence position and the occurrence time of the weather fluctuation can be predicted.

Further, since a general barometer is expensive, it is not practical to arrange a plurality of barometers in a local area. In this embodiment, since the atmospheric pressure sensors 10 can be inexpensively provided using a semiconductor manufacturing technique, a plurality of atmospheric pressure measurement devices 2 are arranged in a mesh shape in a local area, and the more detailed weather fluctuation prediction information can be generated by acquiring the atmospheric pressure values in plural fine positions. Accordingly, it is possible to accurately grasp a slight weather fluctuation before the localized weather fluctuation occurs.

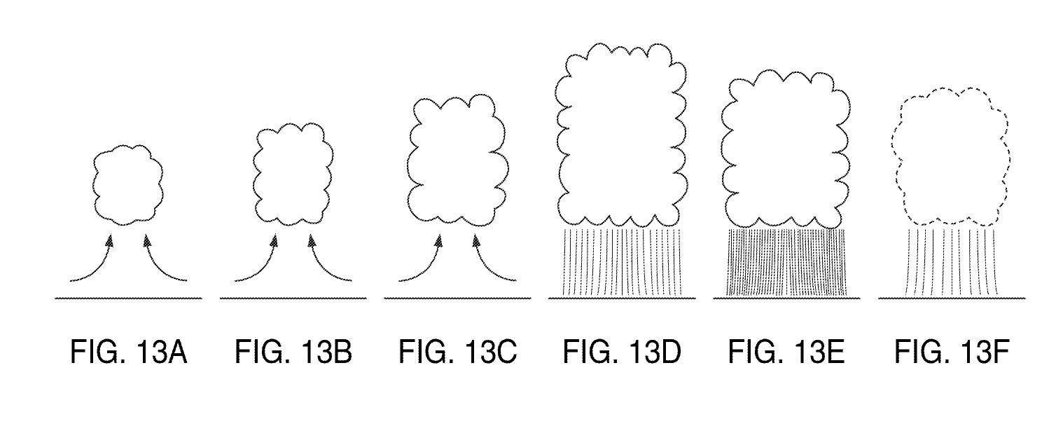

Since the occurrence of the localized low pressure can be acquired, for example, in the stage of FIG. 13A that is an initial development stage of the cumulonimbus cloud, by using the system for providing weather fluctuation prediction information according to this embodiment, there is some possibility of issuing warning information with enough time in comparison to that in the related art until the weather fluctuation such as severe local rain or the like occurs.

### 4. Application Example

The system for providing weather fluctuation prediction information according to this embodiment can be applied for diverse purposes.

For example, it can be used to predict the severe local rain in a specific local area. A plurality of atmospheric pressure measurement devices are prearranged in a mesh shape in an area where the severe local rain is liable to occur such as an urban area, and the atmospheric pressure distribution data is acquired. Since before the severe local rain occurs, the updraft always occurs to cause the occurrence of a localized low pressure area, the moment where the localized low pressure occurs can be acquired and the occurrence position can be specified by monitoring the atmospheric pressure distribution. If the occurrence of the low pressure is acquired, the occurrence/non-occurrence of the severe local rain, the occurrence position, and the occurrence time can be predicted by analyzing the movement direction, movement speed, movement distance, and movement time of the low pressure from the temporal change of the subsequent atmospheric pressure distribution. Accordingly, a warning can be given to the area where occurrence of the severe local rain is predicted before the severe local rain occurs.

Further, for example, in an airport, the system can be used to predict the downburst that occurs near the landing position of the runway. Specifically, a plurality of atmospheric pressure measurement devices are arranged in an area that includes the landing position of the runway, and the landing position and the surrounding atmospheric pressure are calculated. Since before the downburst occurs, the updraft always occurs to cause the occurrence of a localized low pressure area, the moment where the localized low pressure occurs can be acquired and the occurrence position can be specified by monitoring the landing position and the size of the surrounding atmospheric pressure. If the low pressure occurs in the neighborhood of the landing position, the subsequent landing position and the temporal change of the surrounding atmospheric are recorded. Then, since the downburst occurs when the airflow is changed from the updraft to the downdraft, the occurrence of the downburst over a short time can be predicted if the atmospheric pressure in the neighborhood of the landing position goes up or becomes unstable. Accordingly, if there is an airplane in a landing posture, it may be instructed to avoid landing.

### 5. Modified Example

The invention is not limited to the embodiments, but diverse modifications may be made within the scope of the invention.

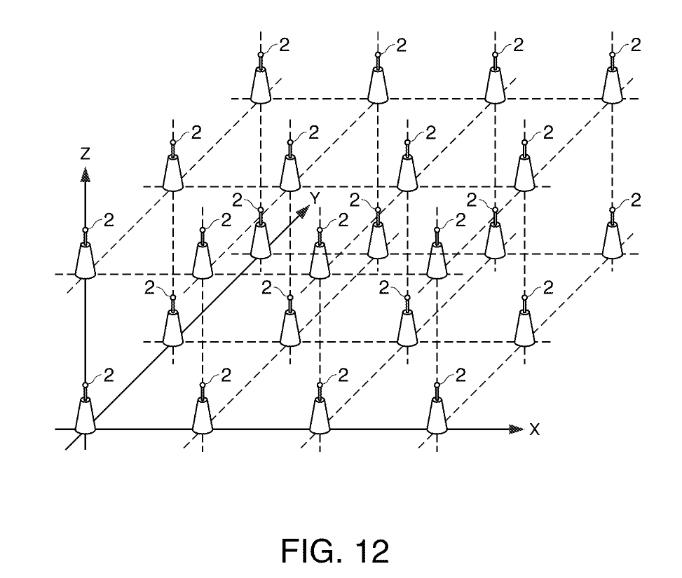

For example, as illustrated in FIG. 12, in consideration of the altitude direction (Z-axis direction), the plurality of atmospheric pressure measurement devices 2 maybe modified to be arranged in a three-dimensional mesh shape in an XYZ space of a specific local area. However, the distances between the atmospheric pressure devices may not be constant. That is, the observation mesh may not have a constant size, and in practice, it is considered that the atmospheric pressure measurement device 2 is installed on a roof of a building in addition to a base station of a mobile phone, a convenience store, a smart grid electricity meter, or the like. By doing so, more detailed observation mesh is formed, and thus more profitable weather fluctuation prediction information can be provided.

Further, in this embodiment, although the atmospheric pressure measurement devices 2 are installed in fixed points, at least some of the atmospheric pressure measurement devices 2 may be installed on a moving body such as a vehicle. Even in this case, the GPS (Global Positioning System) is mounted on the moving body, the atmospheric pressure measurement device 2 transmits position information of the moving body together with the atmospheric pressure data, and the data processing device 4 acquires (stores) the atmospheric pressure data in correspondence to the position of the moving body.

The invention includes substantially the same configuration as the configuration as described in the embodiments of the invention (for example, the configuration having the same function, method, and result, or the configuration having the same purpose and effect). Further, the invention includes the configuration in which non-essential parts of the configuration as described in the above-described embodiments are replaced. Further, the invention includes the configuration having the same working effects as the configuration described in the embodiments of the invention or the configuration that can achieve the same purpose. Further, the invention includes the configuration that is obtained by adding a known technique to the configuration as described above according to the embodiments of the invention.

The entire disclosure of Japanese Patent Application No. 2010-224642, filed Oct. 4, 2010 is expressly incorporated by reference herein.

1. A system for providing weather fluctuation prediction information which provides information to predict specific weather fluctuations that occur due to the change in atmospheric pressure in a specific local area, comprising:
at least one atmospheric pressure measurement device arranged in the specific area; and
a data processing device processing atmospheric pressure data measured by the pressure measurement device,
wherein the atmospheric pressure measurement device includes an atmospheric pressure sensor having a pressure sensing device that changes a resonance frequency according to the atmospheric pressure and outputting the atmospheric pressure data according to an oscillation frequency of the corresponding pressure sensing device, and
the data processing device includes an atmospheric pressure data acquisition unit continuously acquiring the atmospheric pressure data measured by the atmospheric pressure measurement device, and a weather fluctuation prediction information generation unit generating the information to predict the weather fluctuations based on the atmospheric pressure data acquired by the atmospheric pressure data acquisition unit.

2. The system for providing weather fluctuation prediction information according to claim 1, wherein the plurality of the atmospheric pressure measurement devices are arranged in a mesh shape.

3. The system for providing weather fluctuation prediction information according to claim 1, wherein the plurality of the atmospheric pressure measurement devices are arranged with a density which is determined based on a specific standard that is related to the characteristic of the specific area.

4. The system for providing weather fluctuation prediction information according to claim 1, wherein at least some of the plurality of the atmospheric pressure measurement devices are arranged in positions having different altitudes.

5. The system for providing weather fluctuation prediction information according to claim 1, wherein the atmospheric pressure measurement device is arranged at a fixed point that does not move with respect to a ground surface.

6. The system for providing weather fluctuation prediction information according to claim 1, wherein the weather fluctuation prediction information generation unit generates time series of image data that expresses atmospheric pressure distribution in the specific area with colors according to the atmospheric pressure as information to predict the weather fluctuations.

7. The system for providing weather fluctuation prediction information according to claim 1, wherein the data processing device further includes a weather fluctuation prediction unit determining whether or not a specific determination standard is satisfied based on the information to predict the weather fluctuations and predicting the occurrence of the weather fluctuations based on the result of the determination.

8. The system for providing weather fluctuation prediction information according to claim 7, wherein the weather fluctuation prediction unit predicts that the weather fluctuations occur within a predetermined time if a lowering amount of the atmospheric pressure at a specified time in the position of the atmospheric pressure measurement device is larger than a predetermined threshold value.

9. The system for providing weather fluctuation prediction information according to claim 7, wherein the weather fluctuation prediction unit predicts at least one of a weather fluctuation occurrence position and an occurrence time based on the temporal change of the atmospheric pressure in the position of the atmospheric pressure measurement device.

10. The system for providing weather fluctuation prediction information according to claim 1, wherein the pressure sensing device provided in the atmospheric pressure sensor is a piezoelectric double-ended tuning fork resonator.

11. A method of providing weather fluctuation prediction information which provides information to predict specific weather fluctuations that occur due to changes in atmospheric pressure in a specific local area, comprising:
measuring atmospheric pressure using at least one atmospheric pressure measurement device which is arranged in the specific area, and includes an atmospheric pressure sensor having a pressure sensing device that changes a resonance frequency according to the atmospheric pressure and outputting the atmospheric pressure data according to an oscillation frequency of the corresponding pressure sensing device;
continuously acquiring the atmospheric pressure data measured by the atmospheric pressure measurement device; and
generating the information to predict the weather fluctuations based on the atmospheric pressure data acquired in the acquiring of the atmospheric pressure data.

12. The system for providing weather fluctuation prediction information according to claim 2, wherein the plurality of the atmospheric pressure measurement devices are arranged with a density which is determined based on a specific standard that is related to the characteristic of the specific area.

13. The system for providing weather fluctuation prediction information according to claim 2, wherein at least some of the plurality of the atmospheric pressure measurement devices are arranged in positions having different altitudes.

14. The system for providing weather fluctuation prediction information according to claim 2, wherein the atmospheric pressure measurement device is arranged at a fixed point that does not move with respect to a ground surface.

15. The system for providing weather fluctuation prediction information according to claim 2, wherein the weather fluctuation prediction information generation unit generates time series of image data that expresses atmospheric pressure distribution in the specific area with colors according to the atmospheric pressure as information to predict the weather fluctuations.

16. The system for providing weather fluctuation prediction information according to claim 2, wherein the data processing device further includes a weather fluctuation prediction unit determining whether or not a specific determination standard is satisfied based on the information to predict the weather fluctuations and predicting the occurrence of the weather fluctuations based on the result of the determination.

17. The system for providing weather fluctuation prediction information according to claim 16, wherein the weather fluctuation prediction unit predicts that the weather fluctuations occur within a predetermined time if a lowering amount of the atmospheric pressure at a specified time in the position of the atmospheric pressure measurement device is larger than a predetermined threshold value.

18. The system for providing weather fluctuation prediction information according to claim 16, wherein the weather fluctuation prediction unit predicts at least one of a weather fluctuation occurrence position and an occurrence time based on the temporal change of the atmospheric pressure in the position of the atmospheric pressure measurement device.

19. The system for providing weather fluctuation prediction information according to claim 2, wherein the pressure sensing device provided in the atmospheric pressure sensor is a piezoelectric double-ended tuning fork resonator.
